(19) United States
(12) Patent Application Publication
(10) Pub. No.: US 2005/0278732 A1
(43) Pub. Date: Dec. 15, 2005

(54) Digital broadcasting receiver and digital broadcasting receiving method

(75) Inventor: Keiji Tahira, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/143,722

(22) Filed: Jun. 3, 2005

(30) Foreign Application Priority Data
Jun. 11, 2004 (JP) 2004-174367

(51) Int. Cl. H04N 5/46

(52) U.S. Cl. 725/25; 348/558

(57) ABSTRACT

A digital broadcasting receiver comprising a receiving portion configured to receive a digital broadcasting signal, a reproducing portion configured to reproduce an audio signal from the received digital broadcasting signal, a determining portion configured to determine that a state in which an audio signal is not output from the reproducing portion is established depending on a reason thereof, and an alarm sound generating portion configured to generate an alarm sound indicating that the state in which an audio signal is not output from the reproducing portion is established, based on a determination result of the determining portion.

### CROSS-REFERENCE TO RELATED APPLICATIONS

This application is based upon and claims the benefit of priority from prior Japanese Patent Application No. 2004-174367, filed Jun. 11, 2004, the entire contents of which are incorporated herein by reference.

### BACKGROUND OF THE INVENTION

1. Field of the Invention

The present invention relates to a digital broadcasting receiver and a digital broadcasting receiving method which are preferably used in a portable broadcasting receiving terminal and the like for receiving, for example, terrestrial digital broadcasting.

2. Description of the Related Art

As well known, in recent years, not only terrestrial digital broadcasting as well as digital broadcasting via a satellite has been put to practical use, but also mobile broadcasting with service for mainly a mobile object such as a portable broadcasting receiving terminal via the satellite has been planned. Further, in terrestrial digital broadcasting as well, low data rate broadcasting with service for mainly a mobile object such as a portable broadcasting receiving terminal, that is, so-called one-segment broadcasting has been planned.

An analog broadcasting receiver outputs noise sound if it comes to be unable to receive any broadcasting wave. Thus, a user can immediately recognize that it has come to be unable to receive any broadcasting wave even with an audio broadcasting specialized receiver having no picture display means.

On the other hand, the digital broadcasting receiver described above basically generates noise when it has come to be unable to receive any broadcasting wave but instead turns into silent. Jpn. Pat. Appln. KOKAI Publication No. 10-108095 has disclosed a configuration of a receiver which, when it comes to be unable to detect any signal, informs the user that no signal is received through on-screen display, indicator display, alarm sound or the like.

For the digital broadcasting receiver, however, there exists various reasons for inducing a silent state in addition to a case where it comes to be unable to receive any broadcasting wave. Thus, when the silent state is established, it is very difficult for the user to understand its cause and take an appropriate countermeasure.

### BRIEF SUMMARY OF THE INVENTION

According to one aspect of the present invention, there is provided a digital broadcasting receiver comprising: a receiving portion configured to receive a digital broadcasting signal; a reproducing portion configured to reproduce an audio signal from the digital broadcasting signal received by the receiving portion; a determining portion configured to determine that a state in which an audio signal is not output from the reproducing portion is established depending on a reason thereof; and an alarm sound generating portion configured to generate an alarm sound indicating that the state in which an audio signal is not output from the reproducing portion is established, based on a determination result of the determining portion.

According to another aspect of the present invention, there is provided a digital broadcasting receiving method comprising: a first step of receiving a digital broadcasting signal; a second step of reproducing an audio signal from the received digital broadcasting signal; a third step of determining that a state in which an audio signal is not output is established depending on a reason thereof; and a fourth step of generating an alarm sound indicating that the state in which an audio signal is not output is established based on a determination result.

### BRIEF DESCRIPTION OF THE SEVERAL VIEWS OF THE DRAWING

FIG. 1 is a perspective view for explaining an appearance of a broadcasting receiver according to an embodiment of the present invention;

FIG. 2 is a block diagram for explaining a signal processing system of the broadcasting receiver according to the embodiment;

FIG. 3 is a block diagram for explaining the detail of a reception processing portion of the broadcasting receiver according to the embodiment;

FIG. 4 is a flowchart for explaining the major operations of the broadcasting receiver according to the embodiment;

FIG. 5 is a view for explaining a display screen during a major operation of the broadcasting receiver according to the embodiment;

FIG. 6 is a flowchart for explaining a modification of the major operation of the broadcasting receiver according to the embodiment;

FIG. 7 is a flowchart for explaining another modification of the major operation of the broadcasting receiver according to the embodiment;

FIG. 8 is a flowchart for explaining further another modification of the major operation of the broadcasting receiver according to the embodiment;

FIG. 9 is a perspective view for explaining an example in which the broadcasting receiver according to the embodiment is constructed to be foldable; and

FIG. 10 is a perspective view for explaining a state in which the foldable broadcasting receiver according to the embodiment is opened.

### DETAILED DESCRIPTION OF THE INVENTION

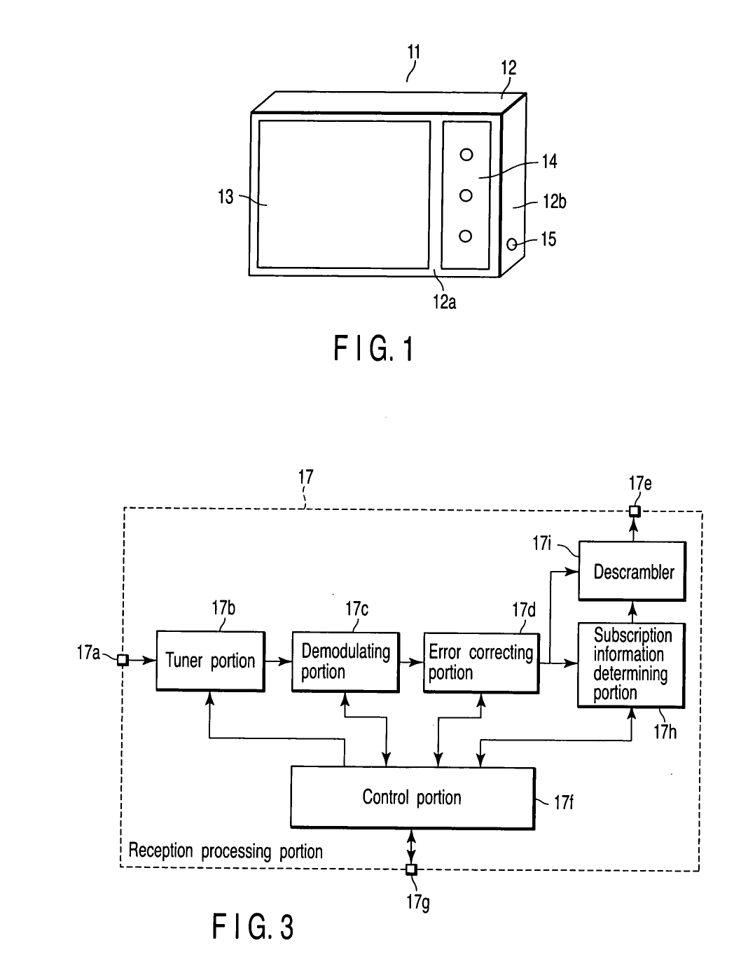

Hereinafter, an embodiment of the present invention will be described in detail with reference to the accompanying drawings. FIG. 1 shows the appearance of a broadcasting receiver 11 that is explained in this embodiment. The broadcasting receiver 11 has a portable thin box-shaped casing 12.

In the casing 12 of the broadcasting receiver 11, a display portion 13 and an operation portion 14 are provided on one flat portion 12a, and an audio output connector 15 to which headphones or the like are to be connected is provided on one side face 12b.

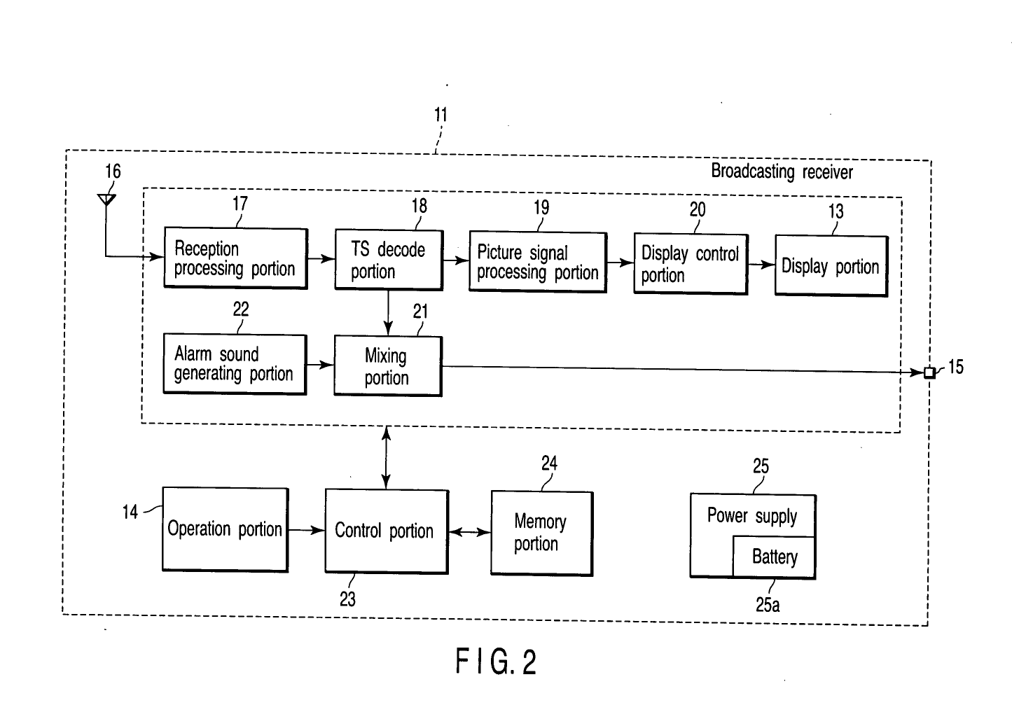

FIG. 2 shows a signal processing system of the broadcasting receiver 11. That is, a digital broadcasting signal received by an antenna 16 contained in the casing 12 is supplied to a reception processing portion 17. The reception processing portion 17 executes tuning, demodulation, error correction and the like on the input digital broadcasting signal so as to generate a transport stream (TS) signal.

Then, the TS signal output from the reception processing portion 17 is supplied to a TS decode portion 18. The TS decode portion 18 executes decoding on the input TS signal to generate a picture signal and an audio signal.

Of them, the picture signal is supplied to a picture signal processing portion 19. The picture signal processing portion 19 executes processing of converting the input picture signal to a configuration corresponding to a display by the display portion 13 and overlaps predetermined graphic signals. Then, a picture signal output from the picture signal processing portion 19 is supplied to the display portion 13 through a display control portion 20 to be used for picture display.

The audio signal generated by the TS decode portion 18 is mixed with various kinds of audio signals selectively output from an alarm sound generating portion 22 by the mixing portion 21, and thereafter, the mixed signal is output from the connector 15 to external headphones or the like and audio sound is reproduced.

In the broadcasting receiver 11, its all operations including the above-described reception operation are controlled by a control portion 23. The control portion 23 incorporates a central processing unit (CPU) or the like, receives operation information from the operation portion 14 and controls respective sections such that the content of the operation is reflected.

In this case, the control portion 23 utilizes a memory portion 24. That is, the memory portion 24 includes a read only memory which stores control programs to be executed by the CPU of the control portion 23, a read/write memory which provides a work area to the CPU, and a nonvolatile memory which stores various kinds of setting information, control information and the like.

The broadcasting receiver 11 includes a power supply 25 for supplying electric power to the respective portions. The power supply 25 generates electric power to be supplied to the respective portions based on electricity of a battery 25a.

FIG. 3 shows the detail of the reception processing portion 17 described above. That is, a digital broadcasting signal received by the antenna 16 is supplied to a tuner portion 17b through an input terminal 17a. Thereafter, the supplied signal is converted to intermediate frequency by the tuner portion 17b and IQ detected, and then, an IQ base band signal is output.

The IQ base band signal is supplied to a demodulating portion 17c, and synchronism detection processing and demodulation processing are performed, and thereafter, error correction processing is carried out by an error correcting portion 17d. The TS signal after error correction is output and supplied to a contract information determining portion 17h and a descrambler 17i.

The contract information determining portion 17h detects contract information from the input TS signal. Then, whether or not the detected contract information corresponds to a preliminarily set subscription is determined, its determination result is output to the control portion 17f and as required, key information for descrambling is output to the descrambler 17i.

The descrambler 17i descrambles the input TS signal by using the key information as required, and the TS signal after the descrambling is output to the TS decode portion 18 through an output terminal 17e.

If a determination result indicating that the contract information corresponds to the subscription is input, the control portion 17f accepts reception of broadcasting of that channel. If a determination result indicating that the contract information does not correspond to the subscription is input, the control portion 17f rejects reception of broadcasting of that channel.

Here, the operation of the reception processing portion 17 is controlled by the control portion 17f. The control portion 17f incorporates a CPU and the like, and controls the respective portions while communicating with the control portion 23 through a control terminal 17g.

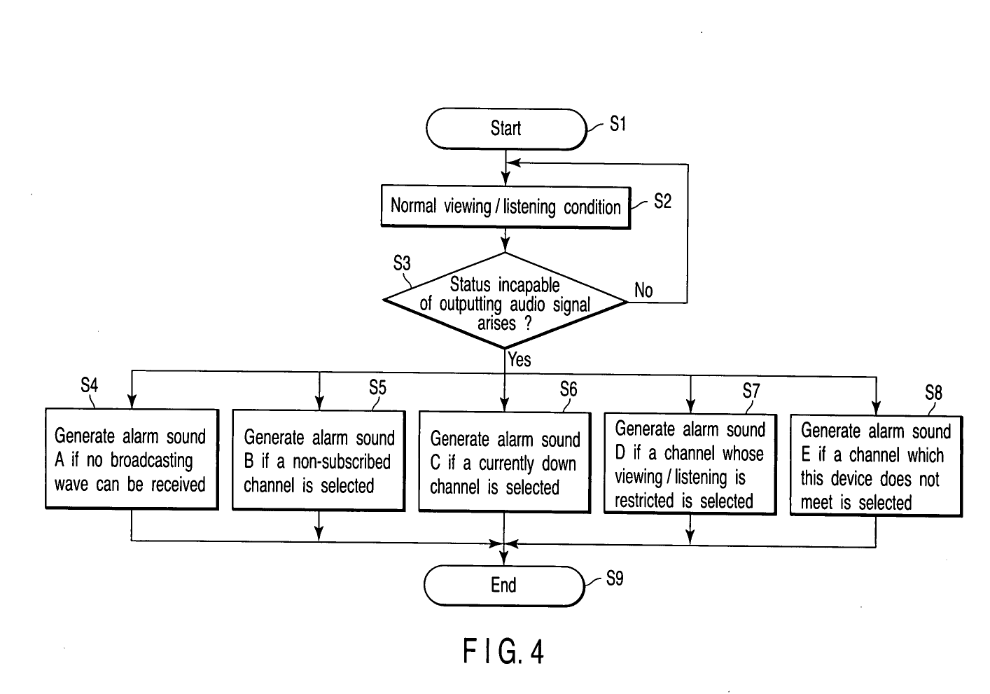

FIG. 4 shows a flowchart indicating operations when the broadcasting receiver 11 turns into silent during receiving of the broadcasting. First, the operation is started (step S1), and in a normal viewing/listening state in which a predetermined channel is being received normally in step S2, the control portion 23 determines whether or not a state incapable of outputting an audio signal has been established in step S3.

Whether or not the state incapable of outputting an audio signal has been established is determined on the following five reasons, whether or not a state incapable of receiving a broadcasting wave has been established, whether or not any non-subscribed channel is selected, whether or not a currently down channel is selected, whether or not a channel whose viewing/listening is restricted is selected, and whether or not any channel which the broadcasting receiver 11 does not meet is selected.

The state incapable of receiving any broadcasting wave can be detected by the control portion 23 when the control portion 17f recognizes a step-out state of the demodulating portion 17c, an error correction disable state in the error correcting portion 17d, or the like.

The fact that any non-subscribed channel is selected can be detected by the control portion 23 when the control portion 17f recognizes a determination result of the contract information determining portion 17h. The fact that a currently down channel is selected can be detected by the control portion 23, based on information of a program to be broadcasted.

The fact that a channel whose viewing/listening is restricted is selected can be detected in such a manner that the control portion 23 compares viewing/listening restriction information contained in the received broadcasting signal with viewing/listening restriction information set in advance in the memory portion 24. The control portion 23 can detect the fact that a channel which the broadcasting receiver 11 does not meet, for example, a channel coded according to a method which the broadcasting receiver 11 does not meet is selected.

In the step S3, if it is determined that the state incapable of outputting any audio signal has been established (YES) because no broadcasting wave can be received, the control portion 23 outputs an audio signal for generating an alarm sound A corresponding to the cause that any broadcasting wave cannot be received from the alarm sound generating portion 22, and then terminates the processing (step S9). Consequently, the user can recognize that the silent state has arisen because a broadcasting wave cannot be received, when the alarm sound A is reproduced from the headphones.

In the step S3, if it is determined that the state incapable of outputting any audio signal has been established because a non-subscribed channel is selected (YES), the control portion 23 outputs an audio signal for generating an alarm sound B corresponding to the cause that the non-subscribed channel is selected from the alarm sound generating portion 22, and then terminates the processing (step S9). Consequently, the user can recognize that the silent state has arisen because the non-subscribed channel is selected, when the alarm sound B is reproduced from the headphones.

In the step S3, if it is determined that the state incapable of outputting any audio signal has been established because a currently down channel is selected (YES), the control portion 23 outputs an audio signal for generating an alarm sound C corresponding to the cause that the currently down channel is selected from the alarm sound generating portion 22, and then terminates the processing (step S9). Consequently, the user can recognize that the silent state has arisen because the currently down channel is selected when the alarm sound C is reproduced from the headphones.

In the step S3, if it is determined that the state incapable of outputting any audio signal has been established because a channel whose viewing/listening is restricted is selected (YES), the control portion 23 outputs an audio signal for generating an alarm sound D corresponding to the cause that the channel whose viewing/listening is restricted is selected from the alarm sound generating portion 22 in step S7, and then terminates the processing (step S9). Consequently, the user can recognize that the silent state has arisen because the channel whose viewing/listening is restricted is selected, when the alarm sound D is reproduced from the headphones.

In the step S3, if it is determined that the state incapable of outputting any audio signal has been established because any channel which the broadcasting receiver 11 does not meet is selected (YES), the control portion 23 outputs an audio signal for generating an alarm sound E corresponding to the cause that the channel which the broadcasting receiver 11 does not meet is selected from the alarm sound generating portion 22 in step S8, and then terminates the processing (step S9). Consequently, the user can recognize that the silent state has arisen because the channel which the broadcasting receiver 11 does not meet is selected, when the alarm sound E is reproduced from the headphones.

The above-described alarm sounds A-E are electronic sounds produced by combining one, two or three sound levels including the duration of the sounds. For example, the alarm sound A is “Pi, Pi”, the alarm sound B is “Pee, Pi”, the alarm sound C is “Pee, Pee”, the alarm sound D is “PiPiPi” and the alarm sound E is “Pee”.

According to the embodiment described above, the different alarm sounds A-E are generated depending on the cause if the silent state arises during reception of broadcasting. Therefore, the user can recognize the reason why the silent state has arisen and take a countermeasure for that reason immediately.

Further, because the reason why the silent state arises is notified through sounds, the user can easily recognize the reason why the silent state has arisen, for example, even if an audio broadcasting specialized channel is being received, that is, even if the user is not watching the display portion 13.

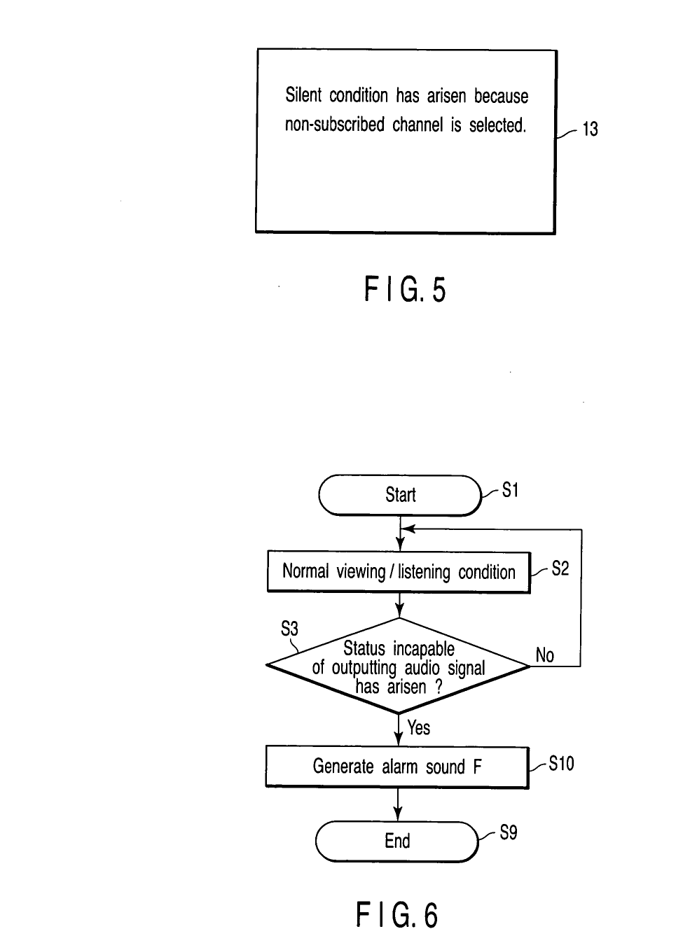

Not only the alarm sounds A-E are generated but also a message indicating the reason for the silent state can be displayed on the display portion 13. In this case, the control portion 23 generates a graphic signal corresponding to a message in the picture signal processing portion 19 and displays it on the display portion 13. For example, such a message as “silent state has arisen because non-subscribed channel is selected” is displayed on the display portion 13 as shown in FIG. 5.

FIG. 6 shows a modification of the above-described embodiment. If explaining in FIG. 6 with like reference numerals attached to the same steps as in FIG. 4, if it is determined that the state incapable of outputting any audio signal has arisen in step S3, the control portion 23 outputs an audio signal for generating an alarm sound F from the alarm sound generating portion 22 regardless of the cause in step S10, and terminates the processing (step S9).

In the example shown in FIG. 6, because the same alarm sound F is generated regardless of the cause if the silent state arises, it is notified to the user that the silent state is produced by any other reason than the failure of the broadcasting receiver 11.

In the meantime, not only the alarm sound F is generated but also a message indicating the reason for the silent state can be displayed on the display portion 13 as shown in FIG. 5. Consequently, even if the user does not watch the display portion 13, the user can recognize a detailed reason by watching the display portion 13 when he listens the alarm sound F.

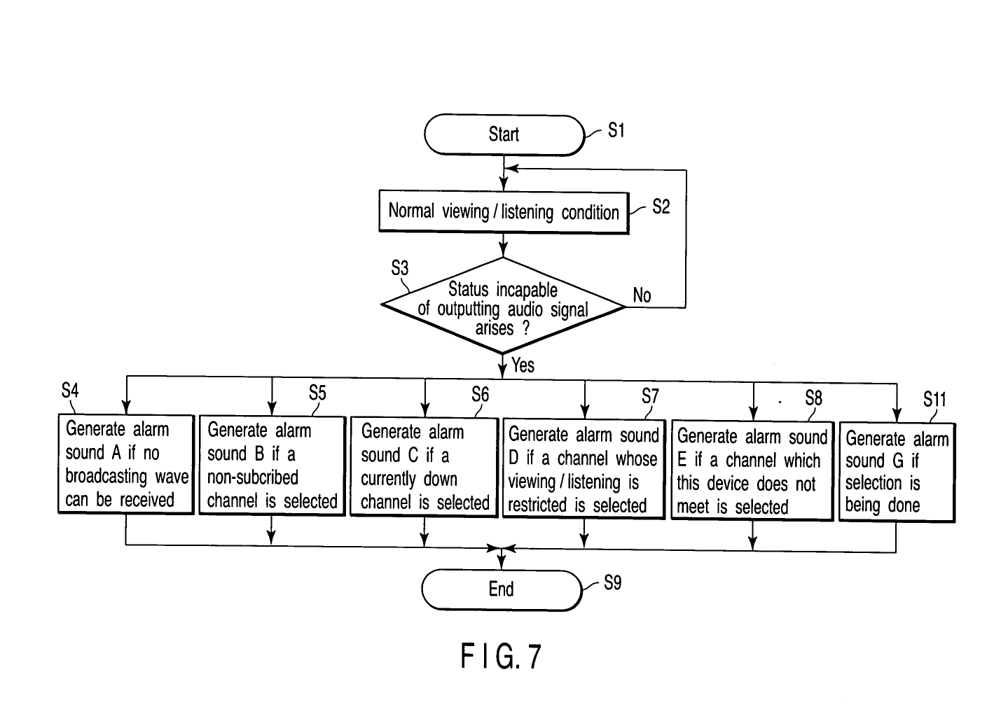

FIG. 7 shows another modification of the embodiment. If explaining in FIG. 7 with like reference numerals attached to the same steps as in FIG. 4, as shown in step S11, whether or not selection is being performed currently is contained in determining whether or not the state incapable of outputting any audio signal has been established in step S3.

That is, in digital broadcasting, particularly in digital broadcasting oriented for a portable broadcasting receiving terminal, an interleave period is generally set longer in order to make recoverable even if a reception signal is interrupted in a burst. Thus, it takes a time for selection processing of a receiving terminal, and it can take several seconds until picture and sound of a newly selected channel are reproduced.

Because the silent state arises during channel selection processing, the control portion 23 outputs an audio signal for generating an alarm sound G corresponding to the cause that channel selection is being done from the alarm sound generating portion 22 in step S11, and terminates the processing (step S9). Consequently, the user can recognize that the silent state arises because the channel selection is being done, when the alarm sound G is reproduced from the headphones.

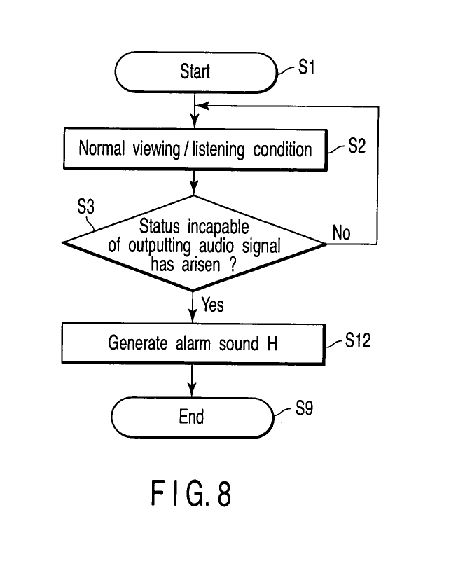

FIG. 8 shows further another modification of the embodiment. If explaining in FIG. 8 with like reference numerals attached to the same steps as in FIG. 7, if it is determined that the state incapable of outputting any audio signal has been established including the state in which the channel selection is being done in step S3 (YES), an audio signal for generating the same alarm sound H is output from the alarm sound generating portion 22 regardless of the reason, and the processing is terminated (step S9).

That is, in the example shown in FIG. 8, because the same alarm sound H is generated regardless of the reason if the silent state arises including the state of channel selection processing, it is notified to the user that the silent state has arisen for any other reason than the failure of the broadcasting receiver 11. In the meantime, not only the alarm sound H is generated, but also a message indicating the cause for the silent state can be displayed on the display portion 13.

Meanwhile, the reason why the silent state has arisen is classified to three types, a case where no broadcasting wave can be received, a case where channel selection is being done, and other cases. It is also possible to generate different alarm sounds for each case.

If a sound of tone corresponding to the genre of a selected program is generated immediately before or immediately after completion of the channel selection processing, the genre of the selected program can be notified without watching the display portion 13.

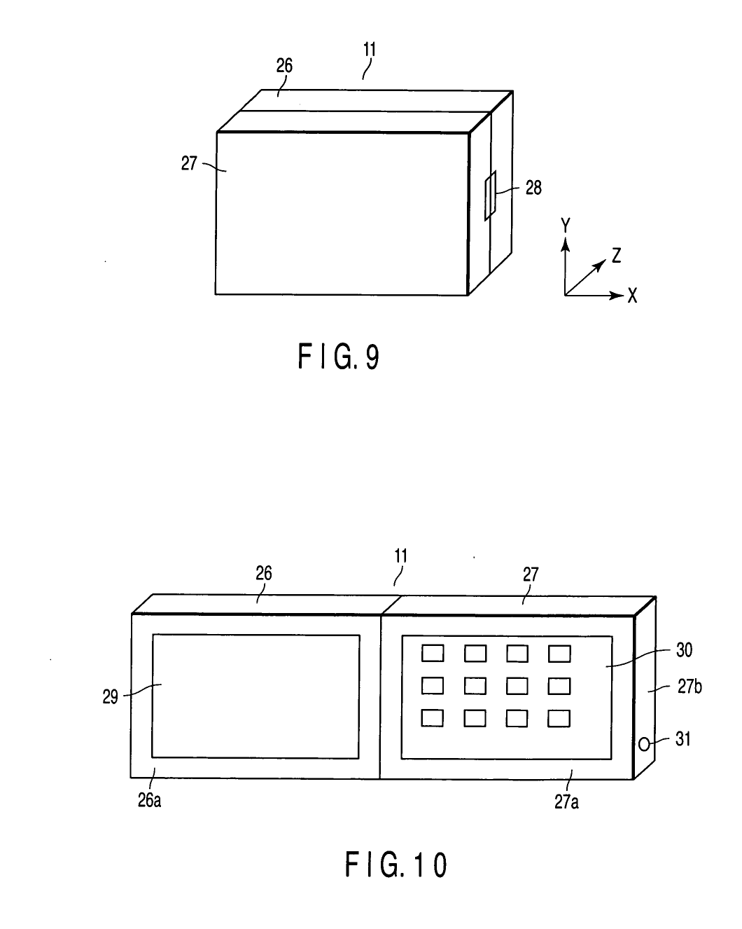

FIGS. 9 and 10 show another example of the broadcasting receiver 11. In this broadcasting receiver 11, two thin box-shaped casings 26, 27 are rotatable connected by a hinge mechanism 28. In this case, by rotating the casing 27 with respect to the casing 26 around a Y-axis by means of the hinge mechanism 28, the broadcasting receiver 11 can be set at a folding position in which they overlap as shown in FIG. 9 and at an expanded position as shown in FIG. 10.

A display portion 29 is provided on a face 26a of the casing 26 opposing the casing 27 at the folding portion. Further, the casing 27 is provided with an operation portion 30 on a face 27a thereof opposing the casing 26 at the folding position. In the meantime, an audio output connector 31 for connecting headphones or the like is provided on one side face 27b of the casing 27.

In such a foldable broadcasting receiver 11, different alarm sounds can be generated depending on the reason if the silent state arises during reception of broadcasting.

The present invention is not restricted to the above-described embodiment but may be modified in various ways within a scope not departing from the gist of the present invention. Further, by combining plural components disclosed in the above-described embodiment appropriately, various kinds of aspects of the present invention can be formed. For example, it is permissible to remove some components from the entire components indicated in the embodiment. Further, it is permissible to combine components from different embodiments appropriately.

1. A digital broadcasting receiver comprising:
a receiving portion configured to receive a digital broadcasting signal;
a reproducing portion configured to reproduce an audio signal from the digital broadcasting signal received by the receiving portion;
a determining portion configured to determine that a state in which an audio signal is not output from the reproducing portion is established depending on a reason thereof; and
an alarm sound generating portion configured to generate an alarm sound indicating that the state in which an audio signal is not output from the reproducing portion is established, based on a determination result of the determining portion.

2. The digital broadcasting receiver according to claim 1, wherein the alarm sound generating portion is configured to generate different alarm sounds depending on a reason why the state in which an audio signal is not outputted from the reproducing portion is established, based on the determination result of the determining portion.

3. The digital broadcasting receiver according to claim 2, wherein the alarm sound generating portion comprises:
an audio generating portion configured to output an audio signal for generating an alarm sound corresponding to a reason why the state in which an audio signal is not output from the reproducing portion is established; and
a mixing portion configured to mix the audio signal generated by the audio generating portion with an output of the reproducing portion.

4. The digital broadcasting receiver according to claim 1, wherein the alarm sound generating portion is configured to generate the same alarm sound regardless of the reason determined by the determining portion why the state in which an audio signal is not output from the reproducing portion is established.

5. The digital broadcasting receiver according to claim 4, wherein the alarm sound generating portion comprises:
an audio generating portion configured to output an audio signal for generating an alarm sound; and
a mixing portion configured to mix the audio signal generated by the audio generating portion with an output of the reproducing portion.

6. The digital broadcasting receiver according to claim 1, wherein the determining portion determines the reason why the state in which an audio signal is not output from the reproducing portion is established to be any one of a case where a broadcasting wave is not received, a case where selection is being done, and other cases.

7. The digital broadcasting receiver according to claim 1, wherein the determining portion determines the reason why the state in which an audio signal is not output from the reproduction portion is established to be any one of a case where no broadcasting wave is not received, a case where a non-subscribed channel is selected, a case where a currently down channel is selected, a case where a channel whose viewing/listening is restricted is selected, a case where a channel which the receiver does not meet is selected, and a case where selection is being done.

8. The digital broadcasting receiver according to claim 1, further comprising a display portion configured to display a message corresponding to the reason why the state in which an audio signal is not output from the reproducing portion is established, based on the determination result of the determining portion.

9. A digital broadcasting receiving method comprising:
a first step of receiving a digital broadcasting signal;
a second step of reproducing an audio signal from the received digital broadcasting signal;
a third step of determining that a state in which an audio signal is not output is established depending on a reason thereof; and
a fourth step of generating an alarm sound indicating that the state in which an audio signal is not output is established based on a determination result.

10. The digital broadcasting receiving method according to claim 9, wherein the fourth step generates different alarm sounds depending on the reason why the state in which an audio signal is not output is established, based on the determination result of the third step.

11. The digital broadcasting receiving method according to claim 9 wherein the fourth step generates the same alarm sound regardless of the reason determined by the third step why the state in which an audio signal is not output is established.

12. The digital broadcasting receiving method according to claim 9, further comprising a fifth step of displaying a message corresponding to the reason why the state in which an audio signal is not output is established, based on the determination result of the third step.
